(19) United States
(12) Patent Application Publication
(10) Pub. No.: US 2009/0317568 A1
(43) Pub. Date: Dec. 24, 2009

(54) MINIATURE WREATH

(76) Inventor: Bradley Allen Hruska, Peshtigo, WI (US)

Correspondence Address: STEVEN H GREENFIELD, 4649 SEMINOLE TRAIL, GREEN BAY, WI, 54313, US

(21) Appl. No.: 12/486,075

(22) Filed: Jun. 17, 2009

Related U.S. Application Data
(60) Provisional application No. 61/074,661, filed on Jun. 22, 2008.

(51) Int. Cl. A41G 1/04; B23P 11/00

(52) U.S. Cl. 428/10; 29/505

(57) ABSTRACT

A miniature wreath constructed of a rigid annular ring containing one or more single-strand garland rope segments intertwined around each other is disclosed. Each single-strand garland rope segment contains two metal wires and at least one ribbon strand from which a plurality of needles protrudes in multiple directions. The metal wires and ribbon strands are intertwined around each other. Additional decorative items may be attached to the wreath.

### RELATED APPLICATIONS

This application claims priority from provisional application No. 61/074,661 filed on Jun. 22, 2008.

### FIELD OF THE INVENTION

The present invention relates to a wreath, and, more specifically, a miniature wreath used for Christmas decorations. The uses of the miniature wreath include but are not limited to being worn on articles of clothing, for example on a jacket lapel or a dress, being hung on a wall, being hung on a Christmas tree, and being used as a candle ring, a magnet on a refrigerator, or a locket.

### BACKGROUND OF THE INVENTION

Several embodiments of similar decorative devices are disclosed in the prior art patents and publications. However, the wreath of the present invention significantly differs from the prior art devices in appearance, in features, in construction, and/or in the methods of assembly. U.S. Pat. No. 5,506,009 discloses a decoration, such as a wreath that has a base with a plurality of openings formed therein and a group of flexible decorating strips which are interwoven through the openings of the base for creating an ornamental design. A method of assembling the decoration is also disclosed. U.S. Publication number 20060210728 relates to a circular wreath having a solid base with holes extending there through so that decorative ornaments can be attached to the wreath and easily released at a later time. In the preferred embodiment, tubes extend through the holes in order to guide and support the decorative ornaments. U.S. Publication number 20060147653 is directed to a decorative wreath comprising a core element with malleable strips of metal woven, tied, or interlaced through the core to create an ornamental design. The metal strips are spray painted in varying patterns, cut with varying widths and lengths, twisted and formed into shapes, and interlaced through the core. Accessories are attached to the wreath depending on the occasion. U.S. Pat. No. 4,100,316 describes a wreath form comprising an annular disc having a spirally-wrapped elastic band extending around the entire outer surface area to hold decorative objects in position on the annular disc. Holes are provided in the disc to receive nails to project there through. A second and similar structure is fastened in spaced relationship to the annular disc structure when an enlarged wreath is desired. U.S. Pat. No. 5,315,492 teaches an illuminated holiday window display ornament formed by a ring frame having ornamentation including LED lights attached to one side with support stanchions projecting through the ornamentation and having glass panel attaching suction cups at the ends thereof A housing at the bottom of the frame contains a battery compartment, on/off switch and music sounding chip and speaker. Additionally, wreaths are featured in design Pat. Nos. D544396, D495619, D406078, D418777 and D356752.

### SUMMARY OF THE PRESENT INVENTION

In one aspect of the present invention, a process for manufacturing an artificial wreath comprises: constructing a single-strand garland rope; assembling multiple-strand garland rope segments from the single-strand garland rope, wherein each segment has a first end and a second end; and joining the first end of each segment with the second end of each segment to produce the wreath.

In another aspect of the present invention, a process for manufacturing a wreath from tree branches comprises: cutting tree branch tips to a desired length to produce branch tips having two cut ends; sealing the cut ends with a sealer; combining one or more of the branch tips into individual bundles; bending each bundle around an annular ring; and attaching said bundle to the annular ring.

In yet another aspect of the present invention, a wreath comprises at least two single-strand rope segments, said single-strand rope segments being intertwined with each other to form a multiple strand garland rope segment having a first end and a second end, said multiple strand garland rope segment being wound in an annular ring, said first end of the garland rope being attached to the second end of the garland rope.

These and other features, aspects and advantages of the present invention will become better understood with reference to the following drawings, description and claims.

### BRIEF DESCRIPTION OF THE DRAWINGS

FIG. 1 shows a portion of the wreath according to an embodiment of the present invention;

FIGS. 2A and 2B show components of the wreath according to an embodiment of the present invention;

FIG. 3 is a wreath according to an embodiment of the present invention;

FIG. 4 is a ring for assembling a wreath according to an embodiment of the present invention;

FIG. 5 illustrates another portion of the wreath according to an embodiment of the present invention;

FIG. 6 is a wreath according to an embodiment of the present invention; and

FIG. 7 is a wreath according to an embodiment of the present invention.

### DETAILED DESCRIPTION OF THE INVENTION

The miniature wreath of the present invention comprises a substantially rigid artificial or natural garland, or a combination of natural and artificial garland bent into an annular ring having a plurality of colored strings or needles attached to it. In an embodiment of the present invention, artificial garland needles having light green, dark green and brown colors, along with silver and gold tinsel strands are used. Other colors may include pink, blue, purple, red, yellow or other metallic or natural green colors from natural tree branches. The uses of the miniature wreath include but are not limited to wearing on articles of clothing, for example on a jacket lapel or a dress, hanging on a wall, hanging on a Christmas tree, and use as a candle ring, a magnet on a refrigerator, or a locket.

The miniature wreath comprises of a substantially rigid annular ring from which a plurality of colored decorative needles extend radially in all directions in a substantially random fashion. The ring is optionally outfitted with one or more ornamental articles including but not limited to cones, beads, bows, candles and LEDs. Depending on the use and application, the various dimensions of the miniature wreath of the present invention can range as follows:
The internal diameter from about 0.5″ up to about 4.5″.
The external diameter from about 1.0″ up to about 5.0″.
The height, measured as the wreath is placed on a flat surface from the surface to the tallest point, from about 0.5″ to about 2″.

In an embodiment of the present invention, the rigid annular ring may contain one single-strand garland rope segment, but preferably at least two single-strand garland rope segments intertwined with each other and having their ends attached to each other. The intertwining of the single-strand rope segments forms a multiple-strand garland rope. Each single-strand rope segment contains two wires and a ribbon intertwined with each other. The ribbon has a center strand from which a plurality of needles protrudes outwardly. In the single-strand rope segment the needles generally point in the same direction but in the finished garland rope form the needles protrude in substantially random and multiple directions.

The metal wire from which each single-strand rope segment is composed may range from about 0.2 mm to about 1.2 mm in diameter. The metal wire composition may include but not limited to iron, steel, brass, copper, and aluminum. However, other materials including but not limited to wood, plastic and glass also fall within the scope of the present invention. An alternate embodiment for a rigid ring includes tree branches or tips originating from evergreen trees including but not limited to Hemlock, Spruce, Cedar, and Balsam.

The needles protruding from the center ribbon strand may include artificial needles, natural needles and combinations of natural and artificial needles. The natural needles may originate from evergreen trees such as Hemlock, Spruce, Cedar, and Balsam or any other such natural material with a needle length of between about 0.25″ to about 1.5″.

In an embodiment of the present invention, colored artificial garland materials that include primary, secondary and tertiary needles may be used. The primary needles are light green and dark green needles; however, other colors may be used depending on the application. The secondary needles are brown needles. Primary and secondary needles may be made of PVC or similar material. Tertiary needles may comprise of silver and gold tinsel highlights and are made of Mylar® or other metallic color foil-like material.

In an alternate embodiment, only primary and secondary needles are used, but without the tertiary needles. The range of the artificial garland dimensions needles are as follows:
Primary needle length ranges from about 5 mm to about 75 mm.
Secondary needle length ranges from about 2 mm to about 75 mm.
Tertiary needles length ranges from about 1 mm to about 75 mm.
Primary needle width ranges from about 0.3 mm to about 8 mm.
Secondary needle width ranges from about 0.3 mm to about 8 mm.
Tertiary needles width ranges from about 0.3 mm to about 8 mm.
Primary needle thickness ranges from about 0.03 mm to about 2 mm.
Secondary needle thickness ranges from about 0.03 mm to about 2 mm.
Tertiary needles thickness ranges from about 0.03 mm to about 2 mm.

The miniature wreath has a front side optionally used for decorative attachments and a back for optionally attaching a fastening device such as a pin or a magnet for fastening onto other objects such as articles of clothing or hanging from another object such as a wall or Christmas tree.

In one embodiment of the present invention, no decorations are attached to the wreath. In an alternate embodiment, decorative articles including but not limited to cones, beads, bows and candles are attached to the wreath by means of an adhesive. The adhesive means include but are not limited to hot melt, crazy glue, super glue, double sided tape and epoxy glue. Mechanical attaching means including but not limited to wires, threads, and rings also fall within the framework of the present invention.

The cones may be natural or artificial. Natural cones originate from trees including but not limited to Alder, Birch, Cedar, Hemlock, Redwood, Balsam and Spruce. Artificial cones may be made from plastic, cloth, resin, glass, wood, paper or other rigid or flexible material and would be typically shaped to resemble natural cones. The shape of the cones is generally irregular having the length, width and height dimensions in the range of about 0.25 inches to about 2.5 inches. The cones may be used in their natural colors or may be painted to most other colors before attaching them onto the wreath. Light colors such as white, light silver or gold are preferred.

The beads attached to the wreath are preferably substantially spherical but may have other irregular shapes having any of the length, width and height dimensions in the range of about 1 mm to about 0.75 inches. The beads may be constructed from cast plastic, resin, cloth, ribbon, glass, wood, metal, paper or other rigid or flexible material that can be cast into a bead shape. Using dried natural berries in lieu or in addition to beads as attachments to the wreath also falls within the scope of the present invention. Beads may be attached as individual pieces or in clusters.

The dimensions of the bow attached to the wreath can have a length and a width in the range of about 0.5 inches to about 2 inches, and a thickness ranging from about 0.1 inches to about 0.75 inches. The bow may be constructed from cast plastic, resin, cloth, ribbon, glass, wood, metal, paper or other rigid or flexible material that can be cast into a bow shape.

The preferred fastening device for fastening the wreath to another object is a pin having a length of about 0.2 inches to about 3 inches depending on the size of the wreath. The pin is attached to the wreath by means of an adhesive in a manner described above. The pins may be bar pins, safety pins, clasping pins, magnetic pins, clips, hangers, wires, hooks or other similar fastening devices.

One or more LED illuminated decorative articles can be attached to the wreath. The preferred shape of illuminated article represents a candle and its size may range from about 0.05 mm to about 15 mm. A battery device for providing a direct current may be used wired directly to the LED or through an electric switch to turn on or off the power or, alternatively, a socket plug is provided for turning the lights on and off.

The steps for manufacturing a miniature wreath made of artificial garland materials comprise the steps of:
1. Producing a single stranded garland rope. This is typically done using an artificial garland rope winding machine. An embodiment of such a machine is described in U.S. Pat. No. 3,584,449. The process involves feeding into the artificial garland rope winding machine two metal wires and one or more rolls of ribbon laid one on top of the other and sandwiched between the two metal wires which are positioned around the middle of the ribbons. In the machine, the ribbons are sliced from each side of the wire by multiple shears into the desired size needles while the ribbons are twisted and intertwined around the two metal wires. The product of this process is a single-strand garland rope in which all the needles point substantially in one direction and at an angle ranging from about 20 degrees to about 60 degrees relative to the double wires.
2. Producing rope multiple-strand garland rope segments from one or more single-strand garland ropes. This can be accomplished by either:
   a) Twisting together two or more bulk single-strand garland ropes, then cutting the individual segments to the desired length, or
   b) Cutting individual segments out of a bulk single-strand garland rope to the desired length then twisting together two or more single-strand garland rope segments.

The multiple-strand garland rope segments may have lengths between about 5 inches to 22 inches depending on the desired wreath size.

The twisting for both a) and b) may be accomplished by joining the single single-strand garland ropes or the single-strand garland rope segments together, holding one of the ends of the combined segments while rotating the other end of the combined segments. This can be achieved by using a mechanical clamping device such as a claw or pliers for gripping the ends and twisting the ropes manually or with the aid of a rotating device.
3. Joining the ends of the multiple-strand garland rope segments. This is accomplished by looping the segments around a circular object such as a mandrel of an appropriate size. The ends may be joined by twisting the two ends together then breaking off and discarding any excess rope segments. This can be achieved by using a mechanical clamping device such as a claw or pliers for gripping the ends and twisting the ropes manually, or with the aid of a rotating device. Alternative methods for combining and fusing the ends of the segments together include but are not limited to spot welding, sonic welding, thermal welding, or laser welding and the use of adhesives including but not limited to hot melt, crazy glue, super glue, double sided tape and epoxy glue. Mechanical attaching means include but are not limited to rings, wires, threads and hooks. The mandrel gives the wreath a circular shape which remains after the mandrel is removed. The mandrel diameter can vary from about 0.5 inches to about 4.5 inches. Following this step, the needles no longer point in substantially one direction but in all directions and distributed in a random fashion. Bending the segments around the mandrel flattens the needles inside the wreath ring and leaves a distinct opening in its center.
   The steps for manufacturing a miniature wreath made of natural materials comprise of:
1. Cutting the tree branches or tips up to 3 inches in length. Tree species having a needle length of between about 0.25 inches to about 1.5 inches including hemlock, tamarack, balsam, and spruce are suitable for this application.
2. Sealing the cut ends with a sealer. The sealers suitable for this application include but are not limited to epoxies, acrylics, polystyrene, silicones, waxes, Poly Vinyl acetate, polyamides, and urethanes. This step must be taken in order to a) prevent sap from leaking out of the branches and b) prevent the tips from drying out which could result in the loss of needles.
3. Combining one or more of these branches together in a bundle.
4. Fastening the bundle to a ring of an appropriate size. This may be accomplished by the use of clips, rings, wire fingers floral wires or threads and/or attaching the bundle with an adhesive such as hot glue.
5. Attaching decorations and adornments to the finished wreath as previously described including beads, cones, bows, LEDs and candles.

The scope of the present invention also includes the manufacturing of a hybrid miniature wreath that comprises of both natural materials and artificial garland materials. To manufacture a hybrid miniature wreath, single-strand garland rope segments made of both natural and artificial materials are clustered and the ends joined together in following the steps for manufacturing a miniature wreath made of artificial garland materials as described above. Alternatively, the clusters of natural and artificial segments may be inserted during winding of the artificial garland between the wires or inserted into a micro ring or, for example, in the wire fingers of a micro ring in following the steps for manufacturing a miniature wreath made of natural materials as described above.

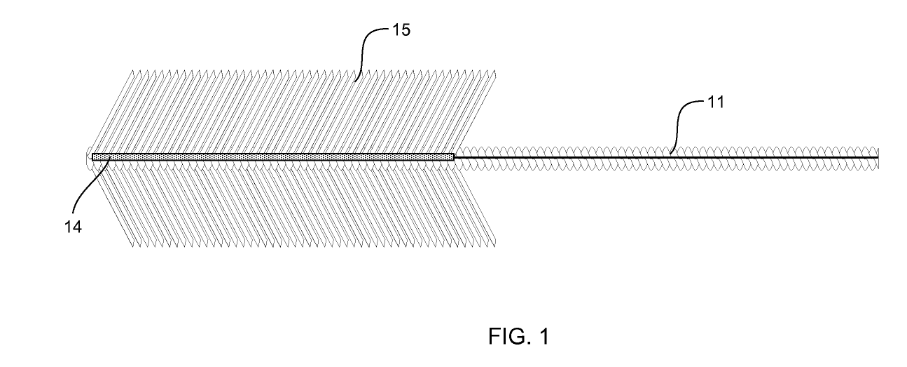

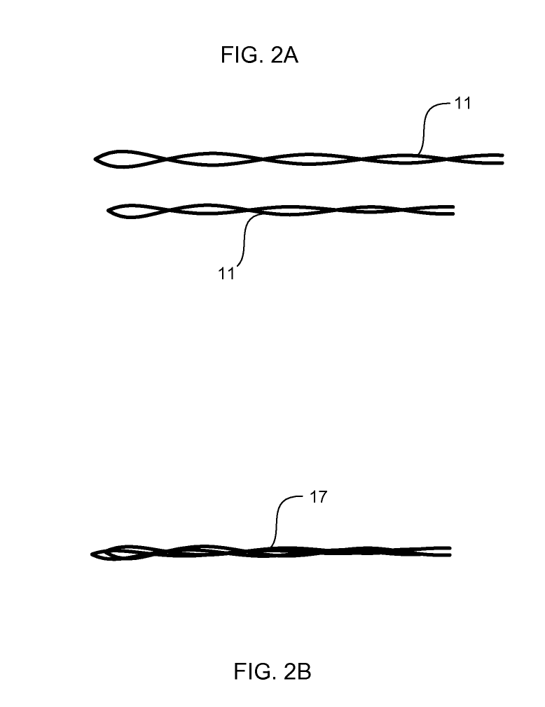

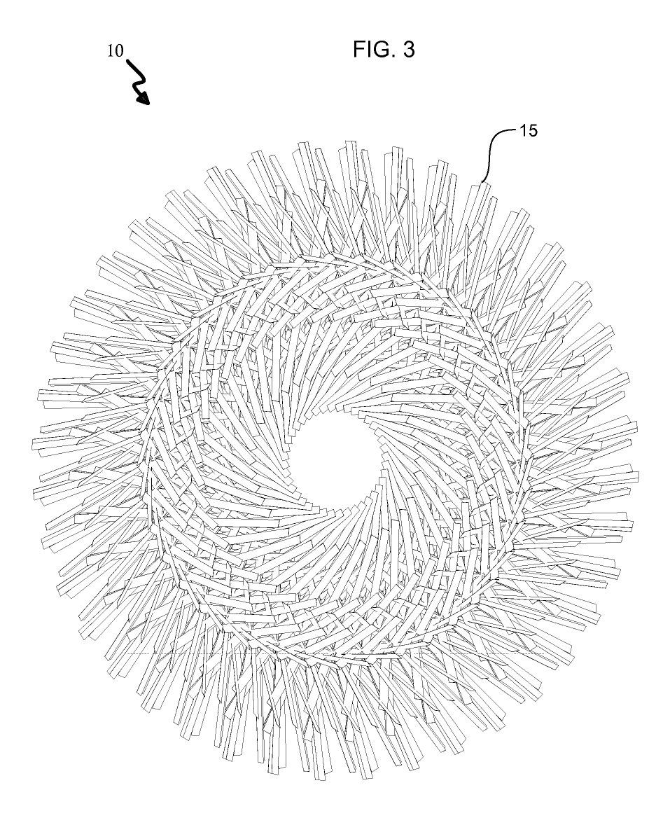

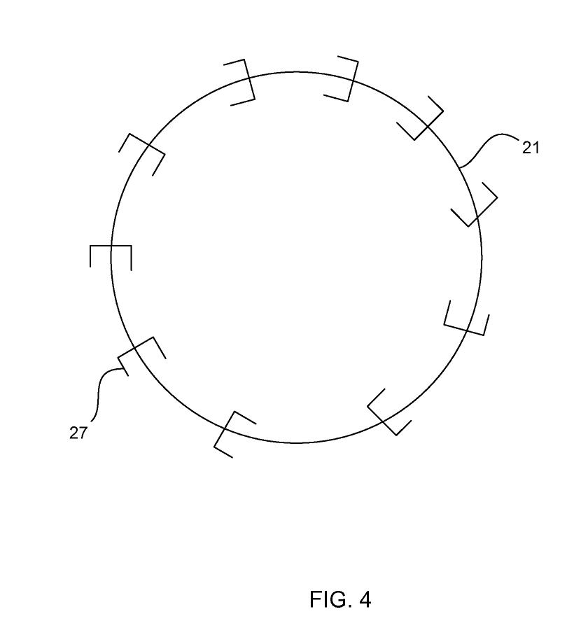

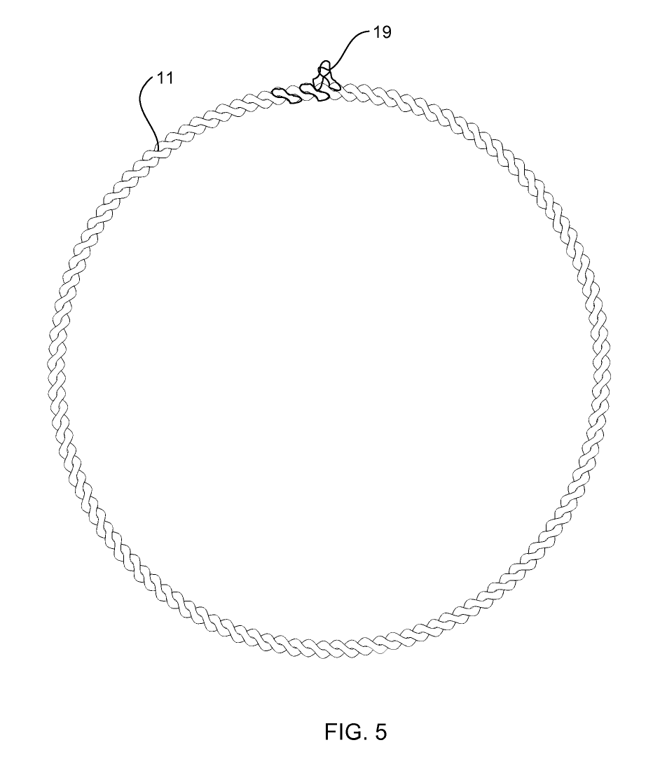

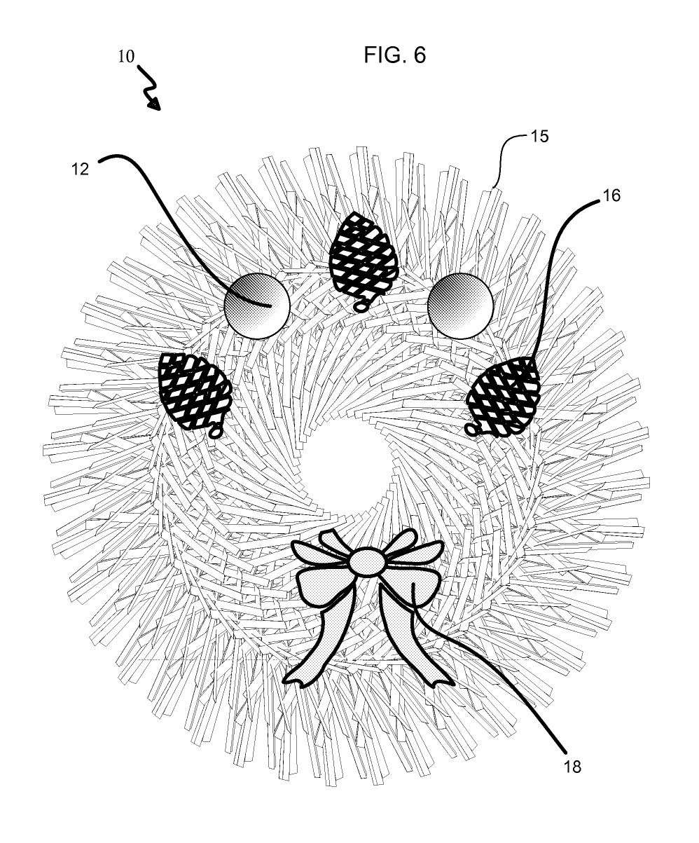

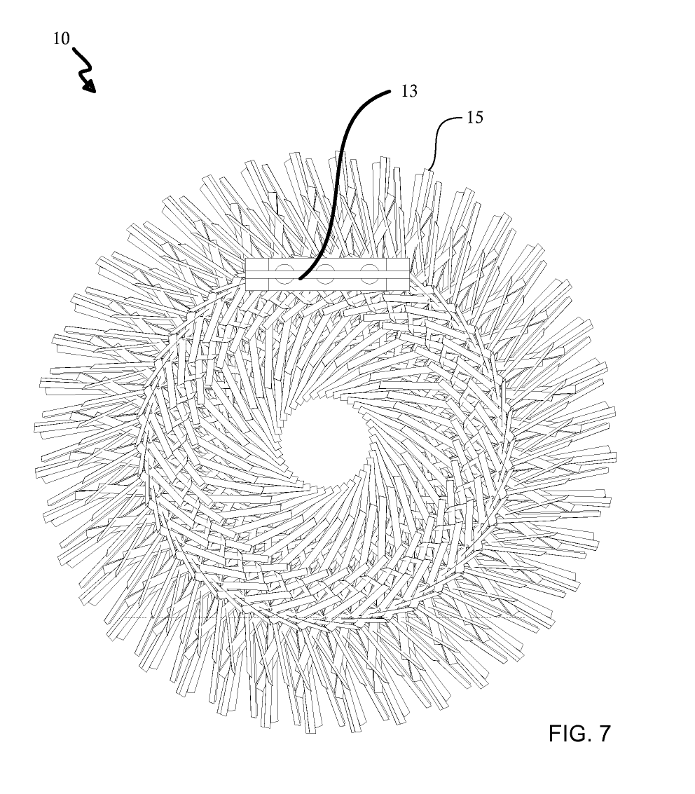

Referring to FIG. 1, there is shown a single-strand garland rope 11 having two metal wires intertwined around each other and around a ribbon strand segment 14 from which needles 15 protrude in about a 60 degree angle relative to the single-strand garland rope 11. FIG. 2A shows two single-strand garland ropes 11 that are twisted around each other forming a double-strand garland rope 17 shown in FIG. 2B. FIG. 3 shows the wreath 10 from which needles 15 protrude. A ring 21 for assembling a wreath made from natural materials has clips 27 used for attaching a bundle of tree tip to the ring 21 is shown in FIG. 4. FIG. 5 shows the rigid annular ring containing two single-strand garland rope segments 11 intertwined around each other indicating a twisted end attachment 19. FIG. 6 shows a wreath 10 onto which three pine cones 16, a butterfly ribbon 18 and two beads 12 are attached. FIG. 7 shows a pin 13 attached to the back of a wreath 10 used for attaching the wreath 10 to other objects such as articles of clothing.

I claim:

1. A process for manufacturing an artificial wreath comprising:
constructing a single-strand garland rope;
assembling multiple-strand garland rope segments from the single-strand garland rope, wherein each segment has a first end and a second end; and
joining the first end of each segment with the second end of each segment to produce the wreath.

2. The process of claim 1, wherein constructing a single strand garland rope comprises:
twisting together two metal wires and at least one ribbon; and
shearing the ribbons to produce a plurality of needles of a predetermined size.

3. The process of claim 1, wherein assembling multiple-strand garland rope segments comprises:
twisting together two or more single-strand garland ropes to produce a multiple-strand garland rope; and
cutting off individual segments from the multiple-strand garland rope to a desired length.

4. The process of claim 2, wherein assembling multiple-strand garland rope segments comprises:
cutting off individual single-strand garland rope segments from the single-strand garland rope to a desired length; and
twisting together two or more individual single-strand garland rope segments.

5. The process of claim 1, wherein joining the first end of each segment with the second end of each segment comprises:
looping each segment around a circular object in a manner that the first end of a segment contacts the second end the segment;
twisting the first end of the segment with the second end of the segment; and
breaking and discarding excess rope fragments.

6. The process of claim 1, wherein joining the first end of each segment with the second end of each segment comprises attaching with glue.

7. The process of claim 1 further comprising attaching decorative items to the wreath.

8. A process for manufacturing a wreath from tree branches comprising:
cutting tree branch tips to a desired length to produce branch tips having two cut ends;
sealing the cut ends with a sealer;
combining one or more of the branch tips into individual bundles;
bending each bundle around a micro ring; and
attaching said bundle to the micro ring.

9. The process of claim 8, wherein attaching the bundle to the ring is accomplished with clips.

10. The process of claim 8, wherein attaching the bundle to the ring is accomplished with rings.

11. The process of claim 8, wherein attaching the bundle to the ring is accomplished with hot glue.

12. The process of claim 8 further comprising attaching decorative items to the wreath.

13. A wreath comprising at least two single-strand rope segments, said single-strand rope segments being intertwined with each other to form a multiple strand garland rope segment having a first end and a second end, said multiple strand garland rope segment being wound in an annular ring, said first end of the garland rope being attached to the second end of the garland rope.

14. The wreath of claim 13, wherein each single-strand rope segment contains two metal wire segments and at least one ribbon strand segment, said metal wire segments and ribbon strand segments of each single-strand rope segment being intertwined around each other, said each ribbon strand segment containing a plurality of needles extending outwardly from each ribbon strand segment.

15. The wreath of claim 13, wherein the wreath comprises two single-strand rope segments.

16. The wreath of claim 13, further comprising decorative items attached to said wreath, said decorative items being selected from the group consisting of beads, cones, bows, candles, and lights.

17. The wreath of claim 14, wherein the needles comprise light green and dark green colored primary needles and brown colored secondary needles.

18. The wreath of claim 17, further comprising tertiary needles consisting of silver and gold tinsel highlights.

19. The wreath of claim 14 further comprising a pin attached to the wreath.

20. The wreath of claim 14 further comprising tree branch tips.
